(19) United States
(12) Patent Application Publication
(10) Pub. No.: US 2003/0233268 A1
(43) Pub. Date: Dec. 18, 2003

(54) Multi-dimensional interdependency based project management

(76) Inventors: Ehsan Taqbeem, Oakland Township, MI (US); Walter J. Battle JR., Farmington Hills, MI (US); Paul E. Scapini, Grosse Pointe Woods, MI (US); Chris W. Kurowski, Highland, MI (US); Richard J. Frase, Schoharie, NY (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/175,563

(22) Filed: Jun. 17, 2002

(51) Int. Cl. G06F 17/60

(52) U.S. Cl. 705/9

(57) ABSTRACT

An improved method is provided for managing a project. The method includes defining a project model that represents the project, where the project is comprised of a plurality of sub-projects, and each of the sub-projects is comprised of a plurality of tasks. Each task is assigned a responsible entity. The improved method further includes identifying interdependency data between the tasks, populating the project model with the interdependency data, and managing the project using the project model. The interdependency data is further defined as being an input requirement to complete a given task in a given sub-project, such that the input requirement is derived from another sub-project having a different responsible entity.

### FIELD OF THE INVENTION

The present invention relates generally to project management and, more particularly to techniques for managing a project using a project model having multi-dimensional interdependency data.

### BACKGROUND OF THE INVENTION

Effective project management is a crucial factor in the success of a project. Among other activities project management involves planning, tracking, cost-estimation and forecasting for various entities during the life-cycle of a given project. Examples of such entities associated with a project include people, money, time, machines, skills and goals. One of the core functions of project management is to coordinate entities with respect to various activities. Another major function of project management is to communicate to all entities their respective responsibilities with respect to each slice of time and objective. Several tools exists to help a project manager plan and track a project.

Several techniques are available to manage projects. Techniques like project evaluation and review technique (PERT) charts, critical path method (CPM) charts and Gantt charts are very useful tools in project management. PERT charts show multiple tasks connected to successor tasks. In a typical PERT chart, a first task starts with a node and all the tasks together form a network of nodes and connecting lines. CPM charts indicate the critical path of a project. Gantt charts are matrices that represent all the tasks to be performed on one axis and the estimated task duration, skill level needed for the task etc. on another axis. The aforementioned techniques are able to relate tasks based on some relationships, and principally based on a time sequence for performing the tasks. However, entities are often related by multiple types of dependencies. Effective project management is decreased when such dependencies are not accounted for during project management. Thus, there is a need for modeling and managing a project that accounts for the multiple interdependencies between project entities.

Computer-based project management tools are available. These tools mostly focus on providing basic project management features and computer implementations of known techniques, such as PERT, CPM, Gantt etc. Conventional project management tools implemented on a computer mostly focus on tracking estimated and actual timelines, and not necessarily on the various interdependencies between the elements of a project. Therefore, the conventional tools do not promote effective collaboration between people working on a given project. Thus, there is a need for techniques and tools which account for the multidimensional interdependencies associated with a given project.

### SUMMARY OF THE INVENTION

Project management is improved by utilizing the multidimensional interdependencies. The project is modeled as consisting of subprojects that are further composed of tasks. Each one of the tasks is to be executed by a designated responsible entity. By using the multi-dimensional interdependencies, the capture of interrelationships between various project elements, for example, between two subtasks or two responsible entities is done in a simple and efficient manner. The multidimensional interdependencies consist of multiple dimensions representing various types of relationships between project elements like tasks. Multidimensional interdependencies are generated by one task as an output and consumed by the other task as input. It is also possible that multidimensional interdependencies are generated by multiple tasks and are consumed by other multiple tasks.

It is possible to build different views of the project and relationships between various project elements using the multidimensional interdependencies. The multidimensional interdependencies support iterating during the project planning phase, and hence help to reduce the expensive iteration costs during the execution phase. The iteration process allows making changes to interdependencies during the planning phase itself. A project model to store and process the multidimensional interdependencies can be built in a variety of ways depending upon the particular tool and applications.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1A is an exemplary representation of a project model;

FIG. 1B illustrates multi-dimensional interdependencies between two tasks of a project;

FIG. 2 illustrates an exemplary graphical representation of the multidimensional interdependencies for a given project model;

FIG. 3 is a chart depicting a tabular form of interdependency data extracted from the project model of the present invention;

FIG. 4 is a graph depicting a comparison between a conventional project management approach and an improved project management approach that employs the project model of the present invention;

FIG. 5 is a screenshot depicting potential change analysis information that may be extracted from the project model of the present invention; and

FIG. 6 is a screenshot depicting hierarchical views of vehicle component information that may be extracted from the project model of the present invention.

### DETAILED DESCRIPTION OF THE PREFERRED EMBODIMENTS

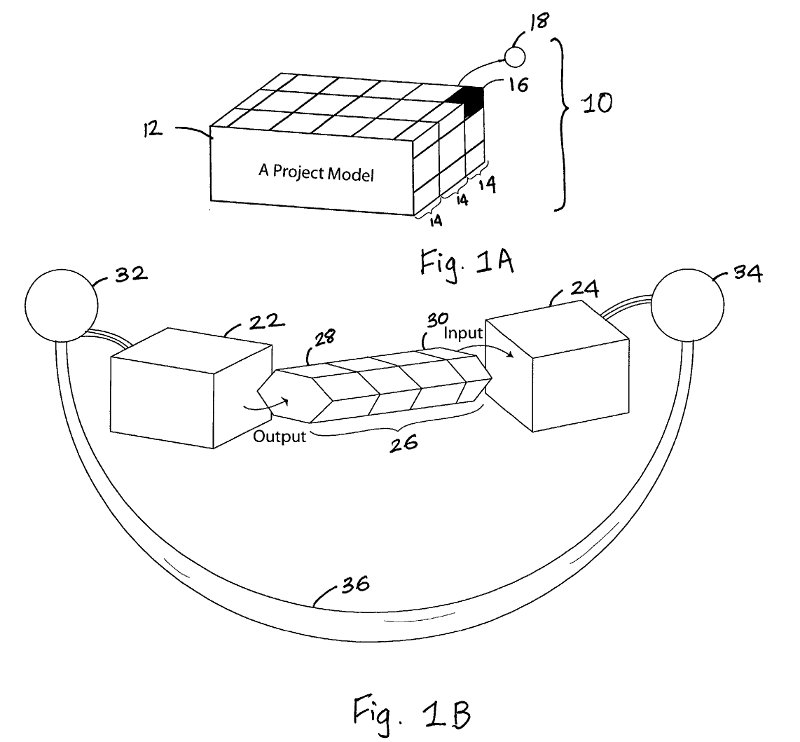

FIG. 1A is an exemplary representation of a project model 10. Information about a project includes a vast number of items. For example, schedules, teams, budgets, technical reports, designs, bill of materials etc. An improved project management system should be able to capture and track a critical quantum of such information parameters at appropriate times and should be able to produce useful output by processing project information. Such a system will require a versatile data-model in order effectively manage a project. The present invention implements such a data-model to store the project information.

A project can be viewed as consisting of several subprojects that in turn are composed of multiple tasks. A data model for storing various kinds of project information is disclosed. The data model for storing project information is called the project model 10. The exemplary representation of the project model is shown as a cube. The project is composed of multiple subprojects 14. Each of the sub-projects 14 is further subdivided into a plurality of tasks 16, such that each one of the tasks is assigned a responsible entity 18. Those skilled in the art will appreciate that the cube is a non-limiting representation of a project model 10. Similarly, those skilled in the art will appreciate that other compositions of a project are also possible.

FIG. 1B illustrates multi-dimensional interdependencies between two tasks of a project. In this example, a first task 22 is related to a second task 24. A first responsible entity 32 is designated to execute the first task 22. Similarly, a second responsible entity 34 is designated to execute the second task 24. The relationship between the two tasks is further characterized by multi-dimensional interdependencies 26.

Multi-dimensional interdependencies 26 are further illustrated by a non-limiting example. For illustration purposes, a subproject for wheel construction having two constituent tasks is considered. First task 22 concerns designing a wheel and is performed by the wheel design group as represented by the first responsible entity 32. The second task 24 represents wheel prototyping which is to be carried out by the prototype building group as represented by the second responsible entity 34. In this case, the multidimensional interdependencies 26 consists of two dimensions: a wheel blueprint 28 and prototyping instructions 30. The prototype building group 34 is not in a position to effectively build a prototype of a wheel until it receives the necessary information, i.e., the wheel blueprint 28 and prototyping instructions 30, from the design group 22. In other words, the first task generates the necessary output that is provided as an input to the second task 24. The above example shows a simple type of information exchange involving two entities. It is envisioned that a single task can produce output which would be required by many other tasks.

Multi-dimensional interdependencies 26 between tasks may take a number of different forms. Non-limiting examples of such interdependency data includes systems, sub-systems, components, systems requirements, component requirements, interface between components, interface between systems, test descriptions and procedures, task timelines, quality units, lifecycles, functional areas, functional objectives, and architectures. It is envisioned that interdependencies 26 can be classified into categories for easy identification. For example, a design category may include component designs, fluid designs, electrical circuit diagrams etc. Those skilled in the art will appreciate that the invention is not limited by the type of dimensions and different types of dimensions are possible depending upon the given application.

The project model 10 may be implemented in a variety of forms. For instance, the project model 10 may be stored in a memory associated with a computing device and processed by appropriate application software. The project model 10 may be further defined as a series of random access files, in an object oriented form, a database, etc. In addition, various known methods can be used to populate a project model 10 with interdependency data. For example, the interdependency data may be manually identified and input into the project model 10. Alternatively, such data may be sourced from existing internal databases, databases provided by external agencies, web-services, and/or internet.

Once the project model is properly populated, several project management functions are improved. For instance, it is now possible for a responsible entity to know in advance what are the necessary dimensions or parameters for it to execute its designated task. Similarly, a responsible entity knows how other tasks are dependent upon it. Instead of responsible entities tracking just the timelines, with the multidimensional interdependencies 26 based project management the responsible entities can perform better by tracking the multiple interdependencies along with timelines.

The responsible entities can collaborate between themselves to better track and adjust various tasks to be executed. The collaboration process is shown as 36 in FIG. 1B. For example, one responsible entity can negotiate the time estimated to complete its task with another responsible entity which in turn can adjust its schedules to the newly negotiated timeframe. Another example of collaboration can be that the inventory department can receive requisitions as dimensions and adjust its task of ordering parts based on the fluctuating production schedules. Further, the overall project management process can be improved as the project can be planned and tracked in many different ways apart from the usual parameters, such as timeframes, costs, and responsibilities.

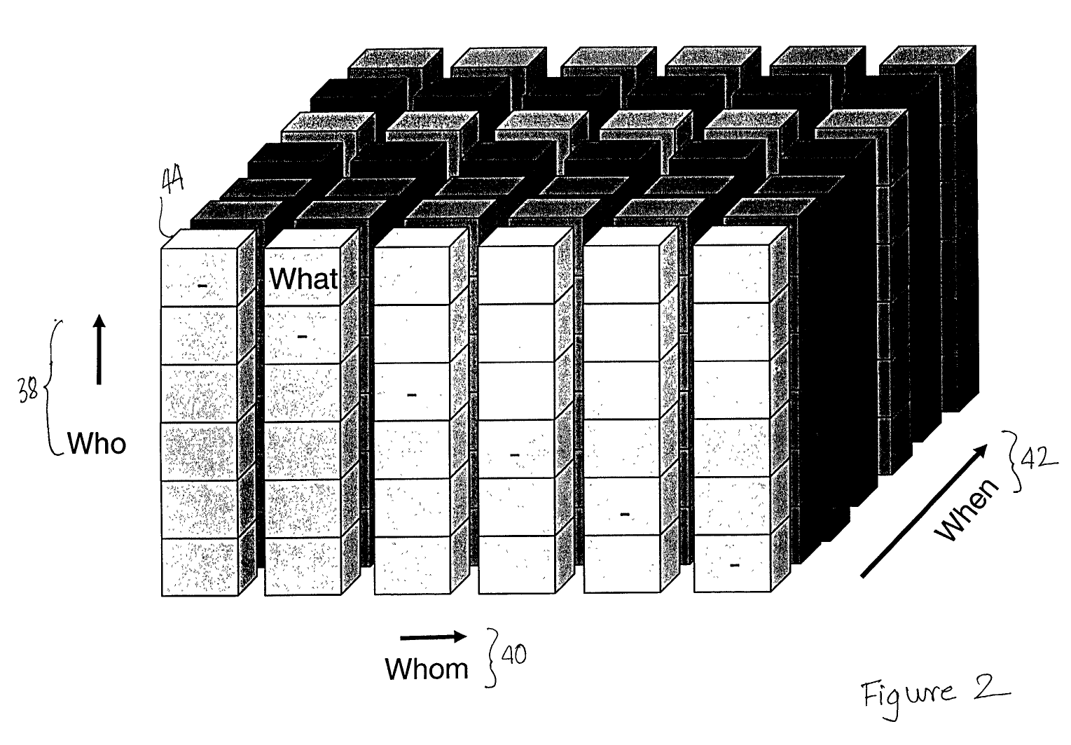

FIG. 2 provides a graphical representation of multidimensional interdependencies for a given project model. The three dimensions shown here are who 38, whom 40, when 42 and the description as what 44. To illustrate, it is assumed that the what 44 represents a transmission system. Dimension who 38 represents the entity that will build the transmission system, the dimension 40 represents for whom the transmission system will be built, and the dimension when 42 represents the time at which the transmission system will be built. A group of all such dimensions is shown as a three-dimensional set of solid bar-graphs. Although three-dimensions are shown, it is readily understood that n-dimension models are within the scope of the present invention. It is further understood that a particular view of the multidimensional interdependencies does not limit the n-dimensional multidimensional interdependencies itself and that it is possible to view multidimensional interdependencies in several different ways depending on the tool and the need.

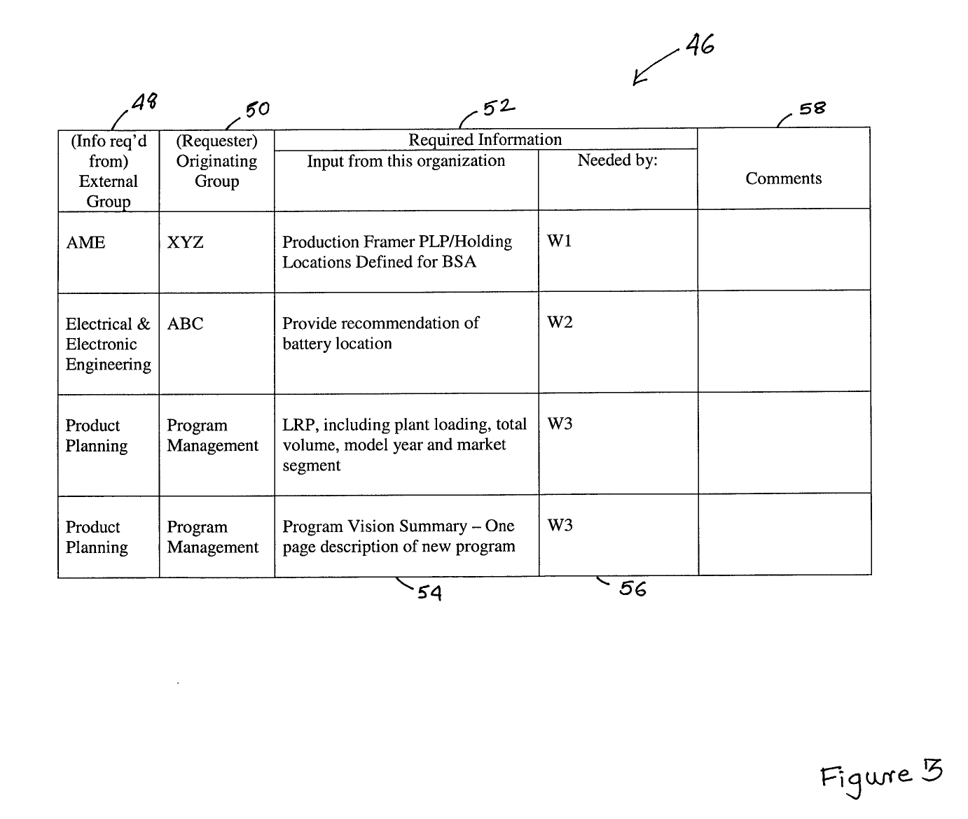

FIG. 3 depicts a tabular form of interdependency data as extracted from a project model. The tabular view illustrates that multiple views from an n-dimensional project model can be created with relative ease. The table 46 provides columns for different dimensions such as source group 48, requesting group 50, required information 52, and comments 58. The information required 52 is further composed of an input requirement 54 and needed by date 56. The comment 58 field accommodates any additional information. As an illustration the first row from the top of the table is considered. The requiring group 56 (‘W1’) needs the input required 54 (‘Production Framer PLP/Holding Locations Defined for BSA’). The requesting group 50 (‘XYZ’) sources the required information from the source group 48 (‘AME’). The illustration shows how multidimensional interdependencies can be used to design and facilitate precise information flow in a project.

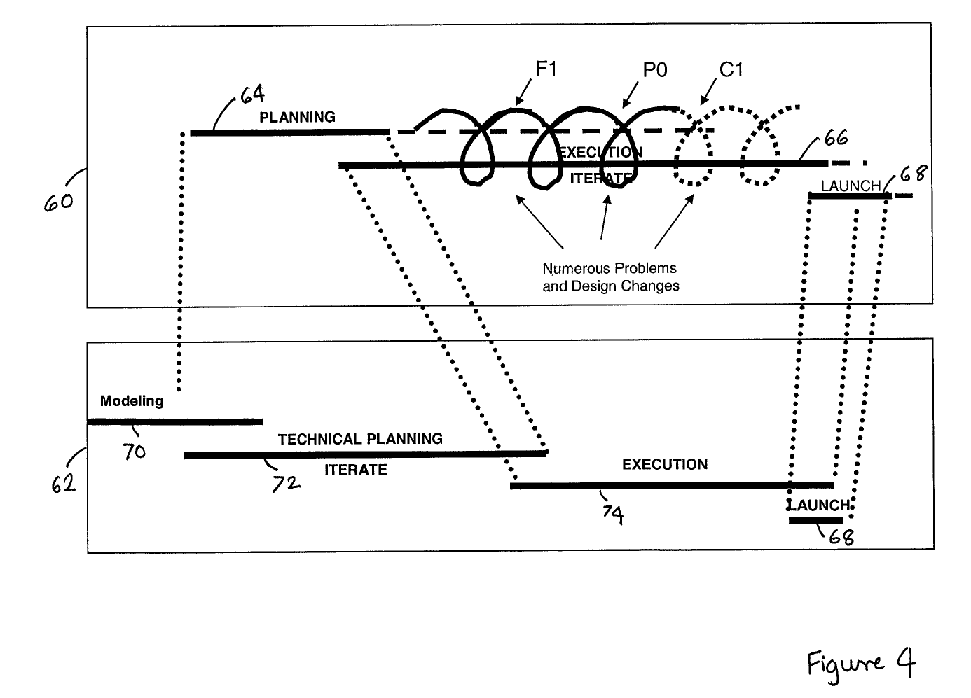

FIG. 4 provides a comparison between a conventional project management approach 60 and an improved project management approach 62 that employs a project model having multi-dimensional interdependency data. Specifically, multi-dimensional interdependency data can be used to increase the efficiency of the technical planning phase as will be further described below. The conventional project 60 progresses through a series of phases including technical planning 64, execution 66, and launch 68. During the execution phase, numerous design problems may be identified and corrected. Several iterations may be need to satisfactorily complete the phase. This iterative process often leads to a long and cumbersome execution phase.

In addition to the conventional project phases, the improved project management approach 62 further includes an additional first phase of project modeling 70. The project modeling phase 70 primarily consists of building and populating a project model having multi-dimensional interdependency data as described above. Technical planning 64 can now be performed with improved accuracy and predictability as all relevant interdependent information has been stored in a project model populated in the modeling phase 70. Further, it is possible to iteratively perform different segments within the technical planning phase 72. in order to pin-point future changes or problems. Such iteration reduces the probable cost and time overruns which may occur during the execution phase 74. If a particular change is carried out, it is easy to find out what other project elements may be affected using the project model. By performing the iterative steps of identifying and correcting design problems during the technical planning 74, it is possible to minimize remedial costs throughout the project.

Various queries of the interdependency data contained in the project model provides the information needed to better manage the project. For instance, queries based on user supplied time or quality units can be generated to track the progress of the project. External data sources can be coupled with the project data-model to provide real time queries. In another instance, the marketing information system can be linked to the project model to match production schedules to varying product demands. The product model could then vary the related dimensions and generate new tasks for the appropriate responsible entities. Tools for querying the project model may be designed as independent or integrated systems. The invention is broad enough to encompass a wide variety of query tools and those skilled in the art would appreciate that particular tool design would depend upon specific application.

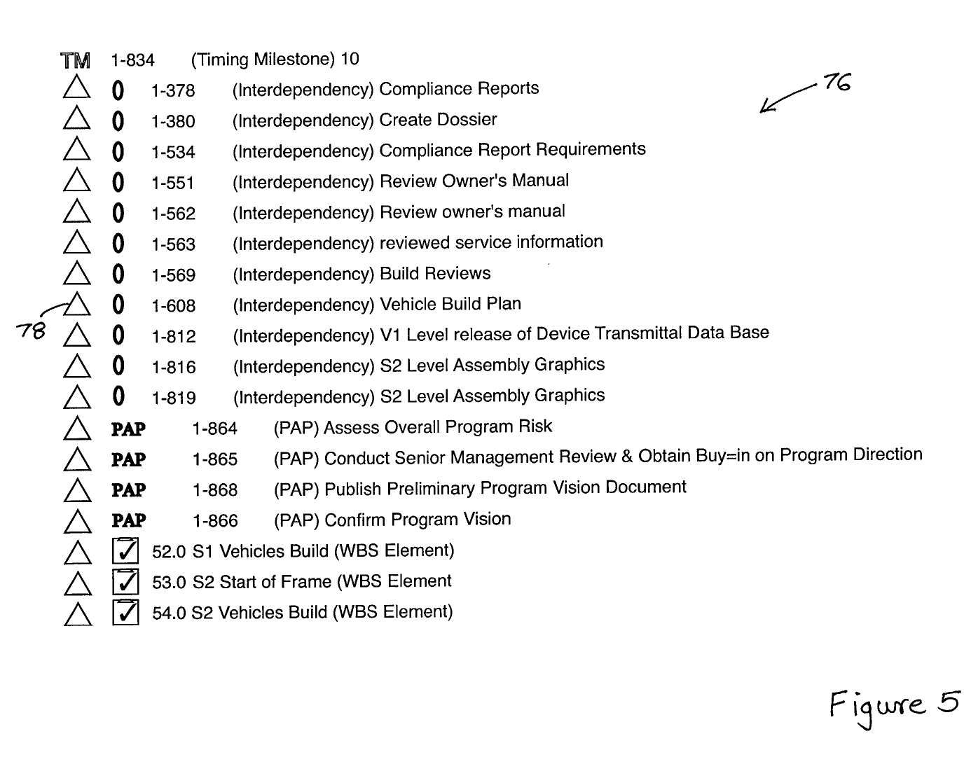

FIG. 5 is a screenshot from a tool performing a potential change analysis. A potential change view 76 may be used to assess the effects of a potential change on a project. For example, a quick analysis of changes to be made on all the interdependencies is assessable if a change is made to the timeframe of vehicle build plan 78. Change assessment using multi-dimensional interdependency data helps all parties involved in a project to assess the impact of changes before a change is undertaken. The potential change view 76 is a non-limiting example. Those skilled in the art will appreciate that different views and suitable tools may be designed for different applications and thus the present invention is not limited by the use of a particular view or tool.

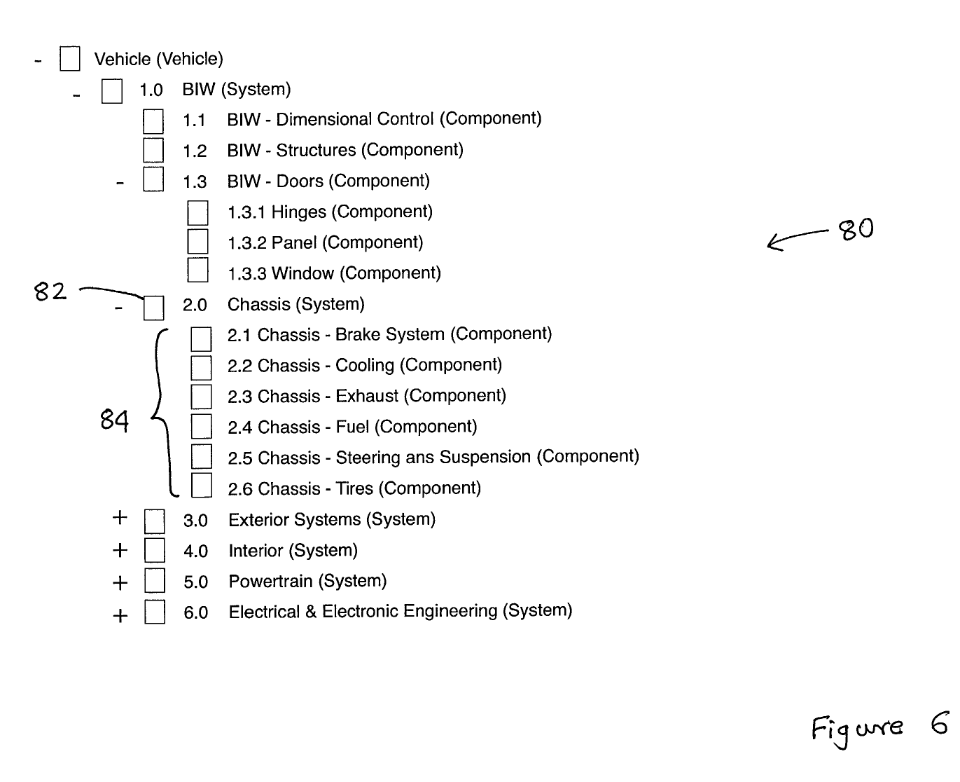

FIG. 6 is a screenshot from a tool that provides hierarchical views of vehicle components. The hierarchical component view 80 illustrates the interdependencies between vehicle components. For example, if a user clicks on the chassis system 82, the user is shown each of the components required to build the chassis system. To reveal additional interdependency data, the user may then click on a given chassis component 84. The user is then shown detailed component data, such as engineering data, materials, past failure test reports, who is building it, timelines for building, etc., related to that particular component. Again, the hierarchical component view 80 is a non-limiting example.

In sum, the present invention uses multi-dimensional interdependencies for managing a project. The multidimensional interdependencies are n-dimensional and can be used for effectively capturing intra-project and inter-project relationships. Use of multidimensional interdependencies leads to decreased project costs and better utilization of resources. The above description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for managing a project, comprising the steps of:
defining a project model that represents the project, where the project is comprised of a plurality of sub-projects associated with the project, and each one of said sub-projects is comprised of a plurality of tasks associated with the sub-project and each one of said tasks is assigned to at least one responsible entity;
identifying interdependency data between said tasks, said interdependency data having a plurality of dimensions, said interdependency data being utilized as an input requirement necessary to complete a given task in a given sub-project and said interdependency data being received as an output from at least one other task;
populating the project model with said interdependency data from at least one source; and
managing the project using the project model.

2. The method of claim 1 wherein the step of managing further comprises:
exchanging said interdependency data between at least two responsible entities for executing said tasks.

3. The method of claim 1 wherein the step of managing further comprises:
modifying a first selection of tasks based on said interdependency data received from a second selection of tasks.

4. The method of claim 1 wherein the step of managing further comprises:
reassigning the responsible entity associated with a first selection of tasks based on said interdependency data received from a second selection of tasks.

5. The method of claim 1 wherein the step of managing further comprises:
modifying the sequence of said tasks within a first said sub-project depending on said interdependency data received from a second said subproject.

6. The method of claim 1 wherein the step of managing further comprises:
defining a first input requirement for a given task by a first responsible entity;
providing the first input requirement to a second responsible entity that is responsible for the given task; and
enabling collaboration amongst the first responsible entity and the second responsible entity to modify the first input requirement.

7. The method of claim 6 further comprising:
defining a revised first input requirement; and
using the revised first input requirement to populate the said project model.

8. The method of claim 1 wherein the said step of populating further comprises:
receiving inputs from at least one user to populate said project data model with received inputs.

9. The method of claim 1 wherein the said step of populating further comprises:
receiving inputs from at least one external source to populate said project data model with received inputs.

10. The method of claim 9 wherein at least one external source is selected from a group consisting of existing databases, external databases, webservices, and internet.

11. The method of claim 1 further comprising the step of:
representing said project model in a memory associated with a computer.

12. The method of claim 1 wherein said interdependency data comprises data having multiple dimensions selected from a group consisting of systems, sub-systems, components, requirements, component requirements, interface between components, interface between systems, test descriptions and procedure, task timelines, quality units, lifecycles, functional areas, functional objectives, and architectures.

13. The method of claim 1 further comprising the step of:
filtering information from said project model based on at least one of said dimensions of said interdependency data; and
transferring the information filtered from said project model to a data sink.

14. The method of claim 1 further comprising the step of:
querying information from said project model based on at least one of said dimensions of said interdependency data.

15. The method of claim 1 further comprising the step of:
determining roles and responsibilities for said responsible entities based on a user-specified time unit.

16. The method of claim 1 further comprising the step of:
determining roles and responsibilities for said responsible entities based on a user specified quality unit.

17. The method of claim 1 further comprising the step of:
iterating prior to execution of said sub-projects and said tasks to correct problems and incorporate changes in the project.

18. A method for managing a project, comprising the steps of:
defining a project model that represents the project, where the project is comprised of a set of sub-projects necessary to complete the project, and each sub-project is comprised of a plurality of tasks necessary to complete the sub-project and at least one entity responsible for completing the plurality of tasks;
identifying interdependency data between the project tasks, the interdependency data being an input requirement to complete a given task in a given sub-project and the input requirement being derived from another subproject having at least one different responsible entity;
populating the project model with the interdependency data; and
managing the project using the project model.

19. The method of claim 18, further comprising the step of:
providing a list of said input requirements for a given said responsible entity from a related said at least one different responsible entity.

20. The method of claim 19, wherein said list of input requirements is based on a user-specified quality unit.

21. The method of claim 19, wherein said list of input requirements is based on a user-specified time unit.

22. The method of claim 18, further comprising the steps of:
filtering information sourced from the project model based on a plurality of factors; and
transferring the information filtered from said project model to a data sink.

23. The method of claim 22, wherein said factors selected from the group consisting of quality unit, time unit, functional areas product architecture, functional objectives, system requirements and ingredient requirements.

24. A project data model for storing project related information, the project model comprising:
a plurality of sub-project data elements;
a plurality of task data elements;
a plurality of responsible-entity-data elements; and
a plurality of element relationships relating said sub-project data elements, said task data elements, and said responsible-entity-data elements.

25. The project data-model of claim 24 further comprising:
a plurality of multi-dimensional interdependencies for relating said subproject-data elements, said task-data elements, said responsible-entities using a plurality of factors.

26. The project data model of claim 25 wherein said factors are selected from a group consisting of systems, sub-systems, components, requirements, component requirements, interface between components, interface between systems, test descriptions and procedure, task timelines, quality units, lifecycles, functional areas, functional objectives, and architectures.

27. The project data-model of claim 24 wherein said sub-project data elements comprise:
a plurality of sub-project levels.
